(19) United States
(12) Patent Application Publication
(10) Pub. No.: US 2026/0260098 A1
(43) Pub. Date: Sep. 3, 2026

(54) IMPROVED CIRCUITRY, CHIP, DEVICE, AND METHOD FOR CONVOLUTION OPERATION

(71) Applicant: SHENZHEN MICROBT ELECTRONICS TECHNOLOGY CO., LTD., SHENZHEN, GUANGDONG (CN)

(72) Inventors: Ke XUE, SHENZHEN, GUANGDONG (CN); Zhijun FAN, SHENZHEN, GUANGDONG (CN); Chao XU, SHENZHEN, GUANGDONG (CN); Jianbo LIU, SHENZHEN, GUANGDONG (CN); Zuoxing YANG, SHENZHEN, GUANGDONG (CN)

(73) Assignee: SHENZHEN MICROBT ELECTRONICS TECHNOLOGY CO., LTD., SHENZHEN, GUANGDONG (CN)

(21) Appl. No.: 18/995,603

(22) PCT Filed: Jul. 10, 2024
(86) PCT No.: PCT/CN2024/104578

§ 371 Date: Jan. 16, 2025

(30) Foreign Application Priority Data
Sep. 5, 2023 (CN) 202311134860.X

(51) Int. Cl. G06N 3/0464; G06F 7/544; G06N 3/063

(52) U.S. Cl. CPC G06N 3/0464; G06F 7/5443; G06N 3/063

(57) ABSTRACT

Improved circuitry, chips, devices and methods for a convolution operation are provided. A circuitry includes a convolution circuit configured to perform a convolution operation in each cycle on: (1) a portion of input data from input channels of a convolutional network, and (2) a portion of coefficient data of convolution kernels of the convolutional network, each convolution kernel associated with a corresponding output channel. The circuitry is configured to keep one of the following items provided to the convolution circuit unchanged across a plurality of consecutive cycles: (1) a first data block that is provided from the input data to the convolution circuit, or (2) a second data block that is provided from coefficient data to the convolution circuit.

### CROSS-REFERENCE TO RELATED APPLICATIONS

This application is a National Stage Application of International Application No. PCT/CN2024/104578, filed Jul. 10, 2024, which claims the benefit of Serial No. 202311134860.X, filed on Sep. 5, 2023 in China, and which applications are incorporated herein by reference. To the extent appropriate, a claim of priority is made to each of the above disclosed applications.

### TECHNICAL FIELD

The present disclosure relates to a field of electronic circuits, and more specifically, to improved circuitry, chips, devices and methods for a convolution operation.

### BACKGROUND

A convolution operation is a common type of mathematical operation. Convolution operations have a wide range of application scenarios. For example, a convolutional neural network (CNN), as one of representative algorithms for deep learning, contains a large number of convolution operations and has a deep structure. As technologies develop and needs grow, the number of convolution operations performed in application scenarios, such as the convolutional neural network, has grown significantly.

### SUMMARY

According to one aspect of the present disclosure, a circuitry for a convolution operation is provided, the circuitry comprising a convolution circuit configured to perform a convolution operation in each cycle on: (1) at least a portion of input data from a plurality of input channels of a convolutional network, and (2) at least a portion of coefficient data of a plurality of convolution kernels of the convolutional network, each convolution kernel of the plurality of convolution kernels being associated with a corresponding output channel of a plurality of output channels of the convolutional network. The circuitry is configured to keep one of the following items provided to the convolution circuit to perform the convolution operation unchanged across a plurality of consecutive cycles: (1) a first data block that is provided from the input data to the convolution circuit, or (2) a second data block that is provided from the coefficient data to the convolution circuit.

According to another aspect of the present disclosure, a method for a convolution operation is provided, including: providing a convolution circuitry, configured to perform a convolution operation in each cycle on: (1) at least a portion of input data from a plurality of input channels of a convolutional network, and (2) at least a portion of coefficient data of a plurality of convolution kernels of the convolutional network, each convolution kernel of the plurality of convolution kernels being associated with a corresponding output channel of a plurality of output channels of the convolutional network; and keeping one of the following items provided to the convolution circuit to perform the convolution operation unchanged across a plurality of consecutive cycles: (1) a first data block that is provided from the input data to the convolution circuit, or (2) a second data block that is provided from the coefficient data to the convolution circuit.

According to another aspect of the present disclosure, a computing chip is provided, comprising the circuitry for a convolution operation as described in the present disclosure.

According to another aspect of the present disclosure, a computing device is provided, comprising the computing chip as described in the present disclosure.

According to another aspect of the present disclosure, a computing apparatus is provided, comprising: one or more processors; and a memory storing computer-executable instructions that, when executed by the one or more processors, cause the one or more processors to perform any method as described in the present disclosure.

According to another aspect of the present disclosure, a non-transitory storage medium storing computer-executable instructions is provided, the instructions, when executed by one or more processors, causing the one or more processors to perform any method as described in the present disclosure.

Through following detailed descriptions of exemplary embodiments of the present disclosure with reference to the accompanying drawings, other features of the present disclosure and advantages thereof will become clear.

### BRIEF DESCRIPTION OF THE DRAWINGS

The accompanying drawings that constitute a part of the specification illustrate embodiments of the present disclosure and are used to explain principles of the present disclosure together with the specification.

The present disclosure may be understood clearly based on the following detailed description with reference to the accompanying drawings.

FIG. 1 illustrates a schematic diagram of an exemplary embodiment of performing a multi-channel convolution operation.

FIG. 2 illustrates a schematic diagram of a logic gate element according to an embodiment of the present disclosure.

FIG. 3 illustrates a schematic diagram of circuitry for a convolution operation according to an embodiment of the present disclosure.

FIG. 4 illustrates a schematic diagram of one exemplary process for performing a multi-channel convolution operation according to an embodiment of the present disclosure.

FIG. 5 illustrates a schematic diagram of another exemplary process for performing a multi-channel convolution operation according to an embodiment of the present disclosure.

FIG. 6 illustrates a flowchart of an exemplary method for convolution operations according to an embodiment of the present disclosure.

FIG. 7 illustrates a schematic diagram of a computing chip according to an embodiment of the present disclosure.

FIG. 8 illustrates a schematic diagram of a computing device according to an embodiment of the present disclosure.

It is to be noted that in the embodiments illustrated below, sometimes the same reference signs are jointly used across different accompanying drawings to represent the same parts or parts with the same function, and repeated descriptions thereof are omitted. In the specification, similar numbers and letters are used to represent similar items. Therefore, once a certain item is defined in an accompanying drawing, it does not need to be further discussed in subsequent accompanying drawings.

For ease of understanding, locations, sizes, scopes, and the like of structures shown in the accompanying drawings or the like sometimes do not represent practical locations, sizes, scopes, and the like. Therefore, the disclosed invention is not limited to the locations, the sizes, the scopes, and the like disclosed in the accompanying drawings or the like. Moreover, the accompanying drawings are not necessarily drawn to scale, and some features may be enlarged to show details of specific components.

### DETAILED DESCRIPTION

A convolutional network is a type of model that is widely used. When training or using the convolutional network, a large number of convolution operations need to be performed. For example, the convolutional network may contain a convolutional layer. The convolutional layer may include one or more convolution kernels. Each convolution kernel may be represented by corresponding coefficient data. The convolution kernel of the convolutional layer may be used to perform a multi-channel convolution operation on input data provided by an input channel. In the multi-channel convolution operation, result values associated with one or more features of the input data may be generated through performing convolution operations on input data from a plurality of input channels and coefficient data of a plurality of convolution kernels.

These result values may be provided, as multi-channel output data, to a plurality of output channels associated with the plurality of convolution kernels.

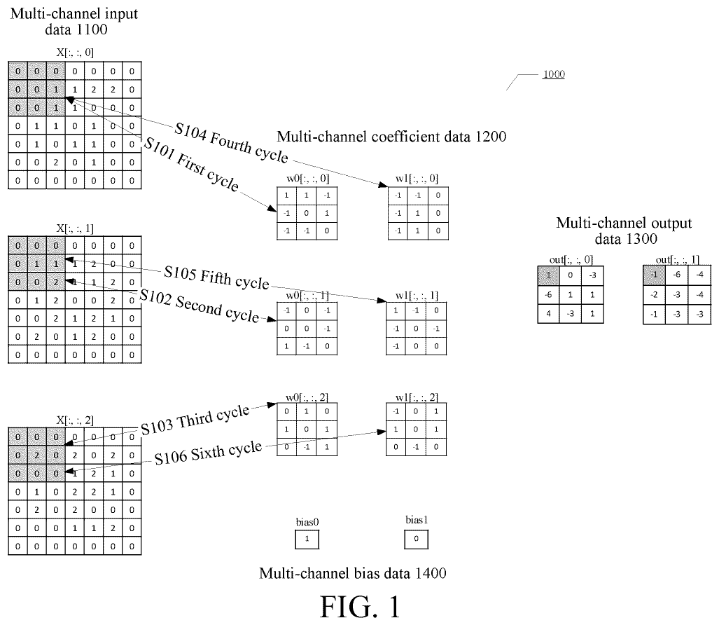

FIG. 1 illustrates a schematic diagram of an exemplary instance 1000 for performing a multi-channel convolution operation. By way of example instead of limitation, multi-channel input data 1100, multi-channel coefficient data 1200, and multi-channel output data 1300 are illustrated in the instance 1000. Optionally, multi-channel bias data 1400 is further illustrated in the instance 1000.

The multi-channel input data 1100 may come from a plurality of input channels of a convolutional network. According to embodiments of the present disclosure, the multi-channel input data 1100 may include various types of input data associated with the convolutional network, without limitation. In some embodiments, the multi-channel input data 1100 may include original input data of the convolutional network. Depending on the purpose of training or using the convolutional network, the original input data may include but is not limited to image data, audio data, video data, sensor data, and the like. In some other embodiments, the multi-channel input data 1100 may be resultant data that is produced by at least a part of the convolutional network. For example, the resultant data may include feature data that is generated by one or more layers of the convolutional network based on the original input data. The feature data may be used as input to an additional convolutional layer of the convolutional network. In still other embodiments, the multi-channel input data 1100 may be a combination of the original input data and the feature data. The data may be provided during training, testing, or use of the convolutional network.

The multi-channel input data 1100 may be collectively represented as a multi-dimensional input array. A size of the multi-dimensional input array may be represented as L×H×CIN, where CIN represents a number of input channels, L represents a width of a two-dimensional array corresponding to the input data of each input channel, and H represents a height of the two-dimensional array corresponding to the input data of each input channel. In the instance 1000, the multi-channel input data 1100 is represented as a multi-dimensional input array X, where CIN=3 and L=H=7. Input data from the first input channel is represented as X[:,:,0], which may be denoted as X0 herein. Input data from the second input channel is represented as X[:,:,1], which may be denoted as X1 herein. Input data from the third input channel is represented as X[:,:,2], which may be denoted as X2 herein. It is noted that, unless otherwise indicated, a value of an index in the present disclosure generally starts from 0. Furthermore, the input data of each input channel is represented as a two-dimensional array with a size of 7×7. Those skilled in the art may understand that the values of L, H, and CIN described above are merely exemplary. In other embodiments, the values of L, H, and CIN may be other appropriate positive integers (for example, integers not less than two) without limitation.

In some optional embodiments, the multi-channel input data 1100 from the three input channels may include image data. In some scenarios, the image data may represent an RGB image. The three input channels may correspond to the R (red) channel, the G (green) channel, and the B (blue) channel of the image data respectively. A value of each data point in the input array X may be associated with a corresponding pixel value in a corresponding channel. In some optional embodiments, the image data may include padding value(s). For example, the periphery of the input data from each input channel in FIG. 1 is filled with values of zero. In some embodiments, the padding value may be any appropriate specified value. In some embodiments, the periphery of the image data may include no padding value.

The multi-channel coefficient data 1200 may be associated with a plurality of convolution kernels of the convolutional network. The convolution kernel may also be referred to as a filter. The result value that is generated by performing a convolution operation on the input data and the coefficient data of the convolution kernel may represent one or more features of the input data. By way of example instead of limitation, the coefficient data may be associated with one or more parameters of the convolutional network. For example, the coefficient data may be associated with one or more weight coefficients of the convolutional network. In a scenario in which the convolutional network is a neural network, the weight coefficient may be a weight coefficient associated with a neuron or a neural connection in a layer of the neural network. In some embodiments (for example, during training of a neural network), the coefficient data of each convolution kernel may change dynamically. In some embodiments (for example, during use of a trained neural network), the coefficient data of each convolution kernel may be fixed.

The multi-channel coefficient data 1200 may include a plurality of coefficient arrays that correspond to the plurality of convolution kernels. Each convolution kernel of the plurality of convolution kernels corresponds to a corresponding output channel of the plurality of output channels of the convolutional network. Accordingly, each coefficient array of the plurality of coefficient arrays also corresponds to a corresponding output channel of the plurality of output channels. In the present disclosure, the number of the plurality of output channels may be represented as COUT. Accordingly, the multi-channel coefficient data 1200 may include COUT coefficient arrays, which may be denoted as w₀, w₁, . . . , and w_{COUT-1}. Each coefficient array may be multi-dimensional. In some embodiments, each coefficient array may be represented as a multi-dimensional array of n×n×CIN, where CIN is the number of the input channels, and n is a parameter associated with a size of the convolution kernel. n is a positive integer not less than two. For example, the size of the convolution kernel may usually be selected as n×n. When n=3, a 3×3 convolution is used. Each coefficient array may have a portion that corresponds to a corresponding input channel of the plurality of input channels. This portion may be represented as a two-dimensional array. In the instance 1000, the multi-channel coefficient data 1200 includes coefficient arrays w₀ and w₁ that are associated with two convolution kernels respectively. Each of the coefficient arrays has a size of 3×3×3. The coefficient array w₀ includes a two-dimensional array w₀[:,:, 0] corresponding to the first input channel, a two-dimensional array w₀[:,:, 1] corresponding to the second input channel and a two-dimensional array w₀[:,:, 2] corresponding to the third input channel. Similarly, the coefficient array w₁ includes a two-dimensional array w₁[:,:, 0] corresponding to the first input channel, a two-dimensional array w₁[:,:, 1] corresponding to the second input channel and a two-dimensional array w₁[:,:, 2] corresponding to the third input channel. Those skilled in the art may understand that the values of COUT, n, and CIN described above are merely exemplary. In other embodiments, the values of COUT, n, and CIN may be other appropriate positive integers, without limitation.

The multi-channel output data 1300 may represent a result of performing a multi-channel convolution operation on the multi-channel input data 1100 and the multi-channel coefficient data 1200. The result of the multi-channel convolution operation may represent one or more features of the multi-channel input data 1100. The multi-channel output data 1300 may contain a plurality of output arrays that correspond to the plurality of output channels of the convolutional network. Each output array of the plurality of output arrays may correspond to a corresponding convolution kernel of the plurality of convolution kernels. In the instance 1000, the multi-channel output data 1300 may include two output arrays, that is, a first output array out[:,:, 0] and a second output array out[:,:, 1]. The first output array and the second output array are associated with the first output channel and the second output channel respectively. The first output array and the second output array are associated with a first convolution kernel and a second convolution kernel respectively. Each of the first output array and the second output array has a size of 3×3. Those skilled in the art may understand that, when the values of L, H, CIN, COUT, and n described above change, the size of the multi-channel coefficient data 1300 may change accordingly.

In an optional embodiment, the multi-channel bias data 1400 is applied in the multi-channel convolution operation. The multi-channel bias data 1400 may include bias value(s) corresponding to individual convolution kernels. This bias value may be added to a convolution result associated with each convolution kernel, for providing an additional correction. The corrected convolution result may be provided to the corresponding output array. In some embodiments (for example, during training of the neural network), the bias value of each convolution kernel may change dynamically. In some embodiments (for example, during use of the trained neural network), the bias value of each convolution kernel may be fixed. In the instance 1000, the multi-channel bias data 1400 includes bias values bias₀ and bias₁ that are associated with the first convolution kernel and the second convolution kernel respectively.

It should be understood that the values of various data points in the multi-channel input data 1100, the multi-channel coefficient data 1200, or the multi-channel bias data 1400 illustrated by the instance 1000 are merely exemplary without limitation. In other embodiments, at least some of the values of the data points may differ from those in the instance 1000. Accordingly, at least some of the values of various data points of the multi-channel output data 1300 may differ from those in the instance 1000.

In practical applications, the convolutional network may be implemented using hardware. For example, a dedicated chip may be used to implement a convolutional neural network. The convolution operation is usually performed by a convolution circuit in hardware. The multi-channel convolution operation is usually divided into a plurality of cycles. The convolution circuit may be configured to perform a convolution operation in each cycle on both of a portion of the multi-channel input data 1100 and a portion of the multi-channel coefficient data 1200. Each convolution operation may include a multiplication-accumulation operation, which includes a set of multiplication operations and an accumulation operation. The result of each convolution operation may correspond to one data point in the multi-channel output data 1300. Across the plurality of cycles, the convolution circuit may traverse a plurality of portions of the multi-channel input data 1100 and a plurality of portions of the multi-channel coefficient data 1200.

An exemplary process S100 of a multi-channel convolution operation according to one method is described in the following in conjunction with FIG. 1. As a part of the multi-channel convolution operation, the process S100 may include steps S101 to S106, which are performed in sequence.

Step S101 may occur in a first cycle. In this step, a portion of input data X0 from the first input channel of the multi-channel input data 1100, which is X[0:2, 0:2, 0], is provided to the convolution circuit to serve as a first data block for the convolution operation. X[0:2, 0:2, 0] is illustrated in shade in FIG. 1. A portion of the coefficient array w₀ of the multi-channel coefficient data 1200 corresponding to the first input channel, which is w₀[:,:, 0], is provided to the convolution circuit to serve as a second data block for the convolution operation. The convolution circuit may perform the convolution operation on the first data block and the second data block. That is, R=X[0:2, 0:2, 0]* w₀[:,:, 0]. The symbol “*” is used in the present disclosure to represent the convolution operation between two data blocks. The convolution operation on the first data block and the second data block may include performing multiplication operations on corresponding pairs of data points in the two data blocks and accumulation of results of respective multiplication operations, as illustrated below:

$$\begin{matrix}R = X [ 0 : 2 , 0 : 2 , 0 ] * {w}_{θ} [ : , : , 0 ] \\ = 0 \times 1 + 0 \times 1 + 0 \times ( - 1 ) + 0 \times ( - 1 ) + \\ 0 \times 0 + 1 \times 1 + 0 \times ( - 1 ) + 0 \times ( - 1 ) + 1 \times 0 \\ = 1\end{matrix}$$

The result R of the current convolution operation may be stored in a register Temp.

The process S100 may then proceed to step S102. Step S102 may occur in a second cycle subsequent to the first cycle. In step S102, a portion of input data X1 from the second input channel of the multi-channel input data 1100, which is X[0:2, 0:2, 1], is provided to the convolution circuit to serve as the first data block. X[0:2, 0:2, 1] is illustrated in shade in FIG. 1. A portion of the coefficient array w₀ of the multi-channel coefficient data 1200 corresponding to the second input channel, which is w₀[:,:, 1], is provided to the convolution circuit to serve as the second data block. In this case, the result R of the convolution operation of the convolution circuit may be calculated as: R=X[0:2, 0:2, 1]* w₀[:,:, 1]=−1. The result R of the current convolution operation may be accumulated to the previous value (which is 1) stored in the register Temp. In this case, the accumulated value in the register Temp becomes 1+(−1)=0.

The process S100 may then proceed to step S103. Step S103 may occur in a third cycle subsequent to the second cycle. In step S103, a portion of input data X2 from the third input channel of the multi-channel input data 1100, which is X[0:2, 0:2, 2], is provided to the convolution circuit to serve as the first data block. X[0:2, 0:2, 2] is illustrated in shade in FIG. 1. A portion of the coefficient array w₀ of the multi-channel coefficient data 1200 corresponding to the third input channel, which is w₀[:,:, 2], is provided to the convolution circuit to serve as the second data block. In this case, the result R of the convolution operation of the convolution circuit may be calculated as: R=X[0:2, 0:2, 2]* w₀[:,:, 2]=0. The result R of the current convolution operation may be accumulated to the previous value (which is 0) stored in the register Temp. In this case, the accumulated value in the register Temp becomes 0+0=0.

After the coefficient array w₀ associated with the first convolution kernel has gone through the convolution operations of the plurality of input channels, a bias value (which is bias₀) associated with the first convolution kernel may be added to the current accumulated value in the register Temp. The result may be used as a corresponding data point of the first output array in the multi-channel output data 1300, that is, out[0,0,0]=0+1=1. This data point is illustrated in shade in FIG. 1. The accumulated value in the register Temp may be cleared to zero.

The process S100 may then proceed to step S104. Step S104 may occur in a fourth cycle subsequent to the third cycle. In step S104, a portion of input data X0 from the first input channel of the multi-channel input data 1100, which is X[0:2, 0:2, 0], is provided to the convolution circuit again to serve as the first data block. A portion of the coefficient array w₁ of the multi-channel coefficient data 1200 corresponding to the first input channel, which is w₁[:,:, 0], is provided to the convolution circuit to serve as the second data block. The convolution circuit may perform multiplication operations on corresponding pairs of data points in the first data block and the second data block and accumulate results of respective multiplication operations. In this case, the result R of the convolution operation of the convolution circuit may be calculated as: R=X[0:2, 0:2, 0]* w₁[:,:, 0]=0. The result R of the current convolution operation may be stored in the register Temp.

The process S100 may then proceed to step S105. Step S105 may occur in a fifth cycle subsequent to the fourth cycle. In step S105, a portion of input data X1 from the second input channel of the multi-channel input data 1100, which is X[0:2, 0:2, 1], is provided to the convolution circuit again to serve as the first data block. A portion of the coefficient array w₁ of the multi-channel coefficient data 1200 corresponding to the second input channel, which is w₁[:,:, 1], is provided to the convolution circuit to serve as the second data block. In this case, the result R of the convolution operation of the convolution circuit may be calculated as: R=X[0:2, 0:2, 1]* w₁[:,:, 1]=−1. The result R of the current convolution operation may be accumulated to the previous value (which is 0) stored in the register Temp. In this case, the accumulated value in the register Temp becomes 0+(−1)=−1.

The process S100 may then proceed to step S106. Step S106 may occur in a sixth cycle subsequent to the fifth cycle. In step S106, a portion of input data X2 from the third input channel of the multi-channel input data 1100, which is X[0:2, 0:2, 2], is provided to the convolution circuit again to serve as the first data block. A portion of the coefficient array w₁ of the multi-channel coefficient data 1200 corresponding to the third input channel, which is w₁[:,:, 2], is provided to the convolution circuit to serve as the second data block. In this case, the result R of the convolution operation of the convolution circuit may be calculated as: R=X[0:2, 0:2, 2]* w₁[:,:, 2]=0. The result R of the current convolution operation may be accumulated to the previous value (which is −1) stored in the register Temp. In this case, the accumulated value in the register Temp becomes (−1)+0=−1.

After the coefficient array w₁ associated with the second convolution kernel has gone through the convolution operations of the plurality of input channels, a bias value (which is bias₁) associated with the second convolution kernel may be added to the current accumulated value in the register Temp. The result may be used as a corresponding data point of the second output array in the multi-channel output data 1300, that is, out[0,0,1]=(−1)+0=−1. This data point is illustrated in shade in FIG. 1. The accumulated value in the register Temp may be cleared to zero.

The process S100 may include additional steps. In an additional step, the input data of each input channel may be slid to obtain the first data blocks that are to be provided to the convolution circuit for the convolution operations. The input data X may be traversed through sliding, thereby obtaining remaining data points in the first output array and the second output array of the multi-channel output data 1300.

The inventors realized that the first data block and the second data block provided to the convolution circuit for the convolution operation always change between the current cycle and a next cycle in the process S100. For example, the first data block changes from X[0:2, 0:2, 0] to X[0:2, 0:2, 1], and the second data block changes from w₀[:,:, 0] to w₀[:,:, 1] between the first cycle and the second cycle. For another example, the first data block changes from X[0:2, 0:2, 1] to X[0:2, 0:2, 2], and the second data block changes from w₀[:,:, 1] to w₀[:,:, 2] between the second cycle and the third cycle. The same is true between other two adjacent cycles. For a hardware circuit that is implemented with semiconductor elements (for example, logic gate elements), frequent changes in the data provided to the semiconductor elements as inputs may adversely increase the power consumption of the logic gate elements.

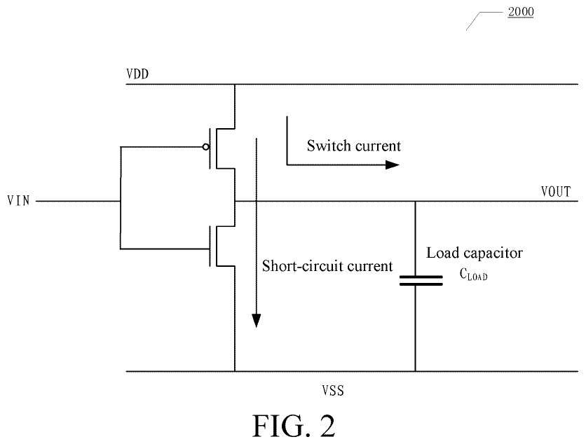

FIG. 2 illustrates a schematic diagram of a logic gate element 2000 according to an embodiment of the present disclosure. The logic gate element 2000 may be a basic hardware unit for implementing the convolution circuit. The logic gate element 2000 includes a PMOS transistor and an NMOS transistor connected to each other. It should be understood that the structure of the logic gate element 2000 in FIG. 2 is merely exemplary. Logic gate elements in practical use may include other structures that are consistent with the general principles set forth in the present disclosure.

Power consumption of the logic gate element 2000 includes static power consumption and dynamic power consumption. The static power consumption is also referred to as leakage power consumption. The dynamic power consumption includes short-circuit power consumption and switch power consumption. When interconnection structures of the PMOS transistor and the NMOS transistor are both on, a short-circuit current is generated, and the resulting power consumption is referred to as short-circuit power consumption. When an input (VIN) of the logic gate element 2000 switches, a load capacitor C_{LOAD} is either charged or discharged, and the resulting power consumption is referred to as switch power consumption. The switch power consumption P_{switch} may be calculated as:

$${P}_{switch} = \frac{1}{2} \times {VDD}^{2} \times {C}_{LOAD} \times {T}_{r}$$

where VDD represents a power supply voltage, and C_{LOAD} represents a load capacitor of the logic gate element 2000. Tr represents a switch rate, which describes a switch frequency of the input of the logic gate element. The switch frequency may be represented as a number of switches per unit time. Therefore, the switch power consumption of the logic gate element 2000 is related to the switch frequency. The switch power consumption of the logic gate element 2000 may be reduced by reducing the switch frequency.

The convolution circuit comprises a large number of logic gate elements that are similar to the logic gate element 2000. For example, these logic gate elements may be configured to implement multipliers or adders of the convolution circuit. These logic gate elements may also be configured to implement registers, or the like. The inventors realized that, when a data block provided to the convolution circuit changes frequently, inputs of the logic gate elements forming the convolution circuit switch frequently. This may cause one or more outputs of these logic gate elements to switch frequently as well. The outputs may serve as inputs to logic gate elements in a next stage. Accordingly, frequent changes in the data block provided to the convolution circuit adversely increase the switch frequency of the logic gate elements of the convolution circuit, thereby increasing the switch power consumption of the logic gate elements. The increased power consumption not only increases computing costs, but also results in heat dissipation issues. This is undesired for hardware (for example, a computing chip) that incorporates a large number of convolution circuits.

The embodiments of the present disclosure provide improved circuitry, chips, devices and methods for convolution operations. In at least one aspect, the embodiments of the present disclosure may reduce switch power consumption of the convolution circuit, thereby reducing overall power consumption associated with the convolution operations.

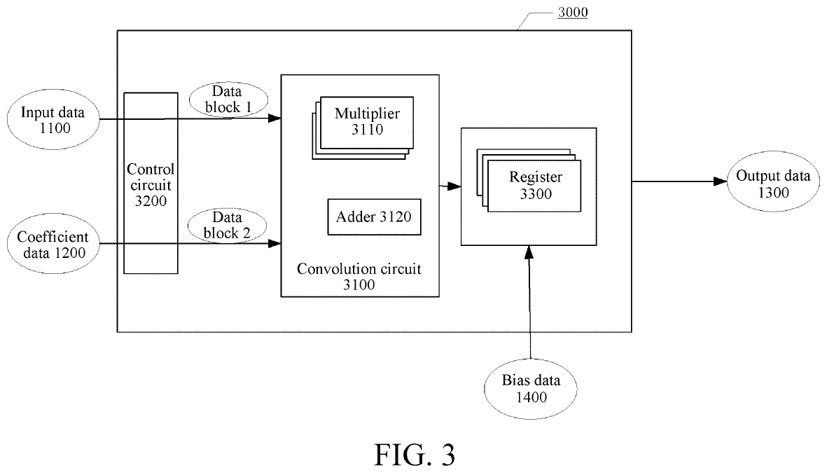

FIG. 3 illustrates a schematic diagram of circuitry 3000 used for convolution operations according to an embodiment of the present disclosure. The circuitry 3000 may include a convolution circuit 3100. The convolution circuit 3100 may be configured to perform a convolution operation in each cycle on: (1) at least a portion of input data from a plurality of input channels of a convolutional network, and (2) at least a portion of coefficient data of a plurality of convolution kernels of the convolutional network.

For example, the input data may be the multi-channel input data 1100 discussed in respect of FIG. 1, and the coefficient data may be the multi-channel coefficient data 1200 discussed in respect of FIG. 1. Each of the plurality of convolution kernels may be associated with a corresponding output channel of a plurality of output channels of the convolutional network. For example, in FIG. 1, the first convolution kernel may be associated with a first output channel, and the second convolution kernel may be associated with a second output channel. The at least portion of the input data from the plurality of input channels of the convolutional network may be used as a first data block for the convolution operation. The at least portion of the coefficient data of the plurality of convolution kernels of the convolutional network may be used as the second data block for the convolution operation. In this cycle, the convolution operation may be performed on the entire first data block and the entire second data block.

Although FIG. 3 illustrates the input data 1100 and the coefficient data 1200 as data sources external to the circuitry 3000, it should be understood that, in some embodiments, the input data 1100 and the coefficient data 1200 may be data sources that are internal to the circuitry 3000. For example, the circuitry 3000 may have an additional internal storage that may be used to receive and store the input data 1100 and the coefficient data 1200. In some scenarios, the coefficient data 1200 is fixed for a given convolutional network. Therefore, the coefficient data 1200 may be stored within the circuitry 3000.

To implement the convolution operation, the convolution circuit 3100 may include one set of multipliers 3110 and an adder 3120. The multipliers 3110 may be configured to perform n×n multiplication operations on corresponding pairs of data points in the first data block from the input data 1100 and the second data block from the coefficient data 1200. The adder 3120 may be configured to accumulate n×n resultant values of these multiplication operations. In some embodiments, the convolution circuit 3100 may include one set of n×n multipliers. In some embodiments, the convolution circuit 3100 may include a plurality of sets of n×n multipliers.

The multipliers 3110 and the adder 3120 may include various logic gate elements. The logic gate elements may be configured to perform the convolution operation through the multiplication-accumulation operation as described above. The multipliers 3110 and the adder 3120 may be implemented using various suitable logic gate elements or combinations thereof, without departing from the scope of the present disclosure. For logic gate elements, the input and output of data are usually triggered by a periodic clock signal (not illustrated in the figure). In the present disclosure, a cycle for a convolution operation may represent a period of time that is required for the convolution circuit 3100 to complete the convolution operation on a pair of data blocks (i.e., the first data block and the second data block). This period of time is usually substantially stable. This period of time may span one or more clock cycles of the clock signal.

According to embodiments of the present disclosure, the circuitry 3000 may optionally include a control circuit 3200. For each cycle, the control circuit 3200 may be configured to select, from the input data 1100 for the convolution operation, the first data block that is to be used for the current cycle, and select, from the coefficient data 1200 for the convolution operation, the second data block that is to be used for the current cycle. In some embodiments, the control circuit 3200 may be implemented as hardwired logic. In some embodiments, the control circuit 3200 may be implemented as a hardware circuit that is controlled by software logic, and the software may be executable code instructions. In some embodiments, the control circuit 3200 may be omitted.

According to embodiments of the present disclosure, the circuitry 3000 may optionally include one or more registers 3300. The register(s) 3300 may be configured to store one or more results of one or more convolution operations, or an accumulated value of the results of a plurality of convolution operations. Although FIG. 3 illustrates the register(s) 3300 as a part of the circuitry 3000, those skilled in the art may understand that the register(s) 3300 may alternatively be located outside of the circuitry 3000.

According to embodiments of the present disclosure, the circuitry 3000 may be configured such that at least one data block provided to convolution circuit 3100 for the convolution operation keeps unchanged across a plurality of consecutive cycles. This may be performed, for example, by the control circuit 3200. In some embodiments, the at least one data block that keeps unchanged includes the first data block that is provided to the convolution circuit from the input data 1100. In some embodiments, the at least one data block that keeps unchanged includes the second data block that is provided to the convolution circuit from the coefficient data 1200.

In some embodiments, the circuitry 3000 may be configured such that the first data block provided to the convolution circuit from the input data 1100 keeps unchanged across the plurality of consecutive cycles, while the second data block provided to the convolution circuit from the coefficient data 1200 may change during these cycles. For example, for a multi-channel convolution operation with CIN input channels and COUT output channels, the circuitry 3000 may be configured to perform CIN rounds of convolution operations. Each round of convolution operations may include consecutive COUT cycles, where the first data block provided from the input data 1100 to the convolution circuit 3100 keeps unchanged in the consecutive COUT cycles.

Specifically, in each cycle of the COUT cycles of one round of convolution operations, the circuitry 3000 may be configured to provide the convolution circuit 3100 with same input data from a same particular input channel to serve as the first data block. In other words, the same input data keeps unchanged across the COUT cycles of the one round of convolution operations. In each cycle, the circuitry 3000 may be configured to provide the convolution circuit 3100 with corresponding coefficient data of a corresponding convolution kernel of the plurality of convolution kernels to serve as the second data block. In some embodiments, the corresponding convolution kernel associated with each cycle is determined based at least on the current cycle. For example, any method for traversing COUT convolution kernels in the COUT cycles may be used, so that the second data blocks provided in different cycles of the COUT cycles come from coefficient data associated with different convolution kernels. In the case that the first data block and the second data block used in each cycle are determined in the above manner, the convolution operation may be performed on the determined first data block and second data block by the convolution circuit 3100 to obtain a corresponding convolution result. The corresponding convolution result may be accumulated to a corresponding register of the plurality of registers 3300.

In some embodiments, additionally, the particular input channel from which the first data block is obtained may be changed across each round of the CIN rounds of convolution operations. In other words, the particular input channels associated with individual rounds of convolution operations may be different. The first data blocks used in individual rounds of convolution operations may come from different input channels. In this way, the CIN input channels may be traversed in the CIN rounds of convolution operations.

In some embodiments, additionally, a plurality of result values associated with the plurality of output channels may be determined based at least on a plurality of accumulated values in the plurality of registers 3300. Optionally, a corresponding bias value of a plurality of bias values included in the bias data 1400 may be added to a corresponding accumulated value in a corresponding register of the plurality of registers 3300, for determining a corresponding result value that is associated with a corresponding output channel of the plurality of output channels. These corresponding result values may represent the plurality of result values associated with the plurality of output channels. The plurality of result values may be output as a part of the multi-channel output data 1300. It should be understood that the bias values are used simply to provide an additional correction to the convolution result. In some scenarios, this additional correction is optional. In some scenarios, this additional correction may not be provided. Accordingly, addition of any bias value may be omitted.

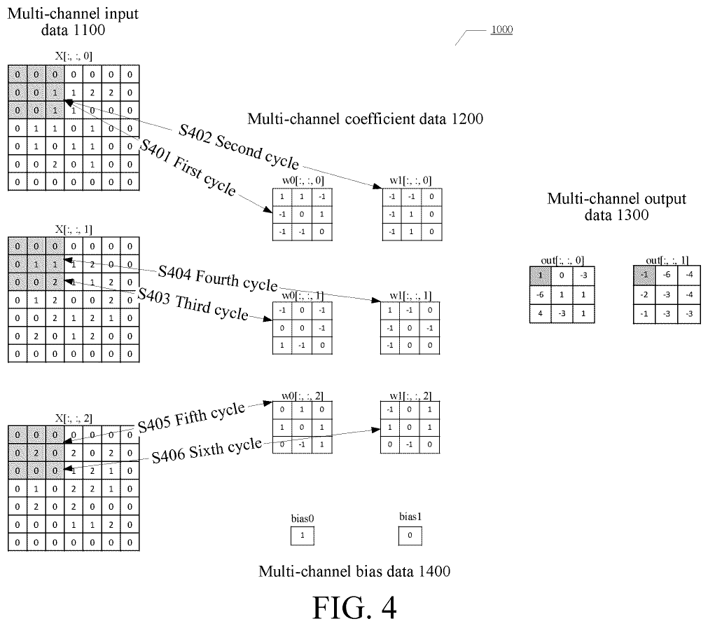

FIG. 4 illustrates a schematic diagram of an exemplary process S400 for performing a multi-channel convolution operation according to an embodiment of the present disclosure. The process S400 is performed in the same instance 1000 as the process S100 described above. Accordingly, the process S400 is performed with respect to the same multi-channel input data 1100, multi-channel coefficient data 1200, and multi-channel bias data 1400. Accordingly, the process S400 produces the same convolution result as the process S100 (which is the multi-channel output data 1300). However, as compared to the process S100, the process S400 has a different scheduling such that the first data block provided to the convolution circuit from the input data 1100 keeps unchanged across a plurality of consecutive cycles.

As a part of the multi-channel convolution operation, the process S400 may include steps S401 to S406, which are performed in sequence. Steps S401 to S406 may be divided into three rounds (CIN=3), each round including two cycles of convolution operations (COUT=2). Specifically, the first round includes steps S401 and S402, the second round includes steps S403 and S404, and the third round includes steps S405 and S406. Each round may be associated with a corresponding input channel of the plurality of input channels. For example, the first round, the second round, and the third round may be associated with the first input channel, the second input channel, and the third input channel respectively.

Step S401 in the first round may occur in the first cycle. In this step, a portion of input data X0 from the first input channel of the multi-channel input data 1100, which is X[0:2, 0:2, 0], is provided to the convolution circuit to serve as the first data block. A portion of the coefficient array w₀ of the multi-channel coefficient data 1200 corresponding to the first input channel, which is w₀[:,:, 0], is provided to the convolution circuit to serve as the second data block. Accordingly, the convolution operation may be calculated as: R=X[0:2, 0:2, 0]* w₀[:,:, 0]=1. The result R of the current convolution operation may be stored in a register Temp₀ that corresponds to the first output channel.

The process S400 may then proceed to step S402 in the first round. Step S402 may occur in the second cycle subsequent to the first cycle. In step S402, the first data block provided to the convolution circuit keeps unchanged, that is, remains as X[0:2, 0:2, 0]. The second data block is changed to a portion of the coefficient array w₁ of the multi-channel coefficient data 1200 corresponding to the first input channel, which is w₁[:,:, 0]. In this case, the result R of the convolution operation of the convolution circuit may be calculated as: R=X[0:2, 0:2, 0]* w₁[:,:, 0]=0. The result R of the current convolution operation may be stored in a register Temp₁ that corresponds to the second output channel.

The process S400 may then proceed to the second round. The second round may start from step S403. Step S403 may occur in the third cycle subsequent to the second cycle. In step S403, the first data block is changed to a portion of input data X1 from the second input channel of the multi-channel input data 1100, which is X[0:2, 0:2, 1]. The second data block is changed to a portion of the coefficient array w₀ of the multi-channel coefficient data 1200 corresponding to the second input channel, which is w₀[:,:, 1]. In this case, the result R of the convolution operation of the convolution circuit may be calculated as: R=X[0:2, 0:2, 1]* w₀[:,:, 1]=−1.

The result R of the current convolution operation may be accumulated to the previous value (which is 1) in the register Temp₀ corresponding to the first output channel. In this case, the accumulated value in the register Temp₀ becomes 1+(−1)=0.

The process S400 may then proceed to step S404 in the second round. Step S404 may occur in the fourth cycle subsequent to the third cycle. In step S404, the first data block remains as X[0:2, 0:2, 1]. The second data block is changed to a portion of the coefficient array w₁ of the multi-channel coefficient data 1200 corresponding to the second input channel, which is w₁[:,:, 1]. In this case, the result R of the convolution operation of the convolution circuit may be calculated as: R=X[0:2, 0:2, 1]* w₁[:,:, 1]=−1. The result R of the current convolution operation may be accumulated to the previous value (which is 0) stored in the register Temp₁ corresponding to the second output channel. In this case, the accumulated value in the register Temp₁ becomes 0+(−1)=−1.

The process S400 may then proceed to the third round. The third round may start from step S405. Step S405 may occur in the fifth cycle subsequent to the fourth cycle. In step S405, the first data block may be changed to a portion of input data X2 from the third input channel of the multi-channel input data 1100, which is X[0:2, 0:2, 2]. The second data block may be changed to a portion of the coefficient array w₀ of the multi-channel coefficient data 1200 corresponding to the third input channel, which is w₀[:,:, 2]. In this case, the result R of the convolution operation of the convolution circuit may be calculated as: R=X[0:2, 0:2, 2]* w₀[:,:, 2]=0. The result R of the current convolution operation may be accumulated to the previous value (which is 0) stored in the register Temp₀ corresponding to the first output channel. In this case, the accumulated value in the register Temp₀ becomes 0+0=0.

After the coefficient array w₀ has gone through the convolution operations of the plurality of input channels, the bias value (which is bias₀) associated with the first convolution kernel may be added to the current accumulated value in the register Temp₀. The obtained result may be used as a corresponding data point of the first output array in the multi-channel output data 1300, that is, out[0,0,0]=0+1=1. The accumulated value in the register Temp₀ may be cleared to zero.

The process S400 may then proceed to step S406 in the third round. Step S406 may occur in the sixth cycle subsequent to the fifth cycle. In step S406, the first data block remains as X[0:2, 0:2, 2]. The second data block is changed to a portion of the coefficient array w₁ of the multi-channel coefficient data 1200 corresponding to the third input channel, which is w₁[:,:, 2]. In this case, the result R of the convolution operation of the convolution circuit may be calculated as: R=X[0:2, 0:2, 2]* w₁[:,:, 2]=0. The result R of the current convolution operation may be accumulated to the previous value (which is −1) stored in the register Temp₁. In this case, the accumulated value in the register Temp₁ becomes (−1)+0=−1.

After the coefficient array w₁ has gone through the convolution operations of the plurality of input channels, the bias value (which is bias₁) associated with the second convolution kernel may be added to the current accumulated value in the register Temp₁. The obtained result may be used as a corresponding data point of the second output array in the multi-channel output data 1300. That is, out[0,0,1]=(−1)+0=−1. This data point is illustrated in shade in FIG. 4. The accumulated value in the register Temp₁ may be cleared to zero.

In the process S400, the first data block from the multi-channel input data 1100 changes across different rounds. For the two calculation cycles in a same round, the first data block keeps unchanged. Therefore, as compared with the process S100, the process S400 may reduce an overall change frequency of the first data block and the second data block of the convolution circuit. For example, the first data block changes six times and the second data block changes six times during the above described six cycles of the process S100, and a sum of the two numbers of changes is twelve. In comparison, the first data block only changes three times and the second data block changes six times in the above described six cycles of the process S400, and the sum of the two numbers of changes is nine. By reducing the overall change frequency of the first data block and the second data block, the switch frequencies of logic gate circuits forming the convolution circuit may be advantageously reduced, thereby reducing the switch power consumption of these logic gate circuits.

It should be understood that the performance sequence of step S401 to step S406 of the process S400 is merely exemplary. In other embodiments, the performance sequence of step S401 to step S406 may be changed while similar technical effects may be achieved. For example, a sequence of steps within a same round may be exchanged, as long as a same first data block is used in each step of the round. Further, the performance sequence of the three rounds may also be changed. For example, the second round (S403 and S404) may be performed first, then the third round (S405 and S406) may be performed, and then the first round (S401 and S402) may be performed. The three rounds may alternatively be performed in another suitable sequence.

It should be understood that the process S400 may include additional rounds. In an additional round, a sliding may be performed on the input data of each input channel to obtain the first data block that is provided to the convolution circuit for the convolution operation. The multi-channel input data 1100 may be traversed through the sliding, thereby obtaining the remaining data points in the first output array and the second output array of the multi-channel output data 1300. The sliding may be based on a predetermined sliding step length. The predetermined sliding step length may be represented as a number of data points that are slid away in a single sliding.

By way of example instead of limitation, the process S400 may include three additional rounds for the instance 1000, that is, a fourth round, a fifth round, and a sixth round. For example, the fourth round, the fifth round, and the sixth round may be respectively associated with the first input channel, the second input channel, and the third input channel of the three input channels. In the fourth round, the first data block may remain as a portion of the input data X0 of the first input channel, for example, X[0:2, 2:4, 0]. Relative to X[0:2, 0:2, 0] in the first round, X[0:2, 2:4, 0] is slid rightwards by the predetermined sliding step length of two. In the two cycles of this round, the second data block may be w₀[:,:, 0] and w₁[:,:, 0] respectively. In the fifth round, the first data block may remain as a portion of the input data X1 of the second input channel, for example, X[0:2, 2:4, 1]. Relative to X[0:2, 0:2, 1] in the second round, X[0:2, 2:4, 1] is slid rightwards by the predetermined sliding step of two. In the two cycles of this round, the second data block may be w₀[:,:, 1] and w₁[:,:, 1] respectively. In the sixth round, the first data block may remain as a portion of the input data X2 of the third input channel, for example, X[0:2, 2:4, 2]. Relative to X[0:2, 0:2, 2] in the second round, X[0:2, 2:4, 2] is slid rightwards by the predetermined sliding step of two. In the two cycles of this round, the second data block may be w #:, :, 2] and w₁[:,:, 2] respectively. The entire input data may be traversed through similar sliding, and one or more rounds may be performed accordingly (the sliding direction may be rightward or downward). In other embodiments, the predetermined sliding step length may be another appropriate positive integer value.

Description is made in the following for the multi-channel input data 1100 and the multi-channel coefficient data 1200, which are more general. As mentioned above, the multi-channel input data 1100 may be represented as a multi-dimensional array with the size of L×H×CIN, where CIN represents the number of the input channels, L represents the width of the two-dimensional array corresponding to the input data of each input channel, and H represents the height of the two-dimensional array corresponding to the input data of each input channel. The multi-channel coefficient data 1200 may be represented as COUT coefficient arrays, w₀, w₁, . . . , and w_{COUT-1}. Each coefficient array may be represented as a multi-dimensional array with a size of n×n×CIN. In this case, the first data block and the second data block provided to the convolution circuit every cycle may be selected as illustrated in Table 1.

TABLE 1

| | Cycle# in the | | | |
|---|---|---|---|---|
| Round# | current round | First data block | Second data block | Register |
| 1 | 1 | X[0: n − 1, 0: n − 1, 0] | w₀[:, :, 0] | Temp₀ |
| | 2 | X[0: n − 1, 0: n − 1, 0] | w₁[:, :, 0] | Temp₁ |
| | . . . | . . . | . . . | . . . |
| | COUT − 1 | X[0: n − 1, 0: n − 1, 0] | w_{COUT-2}[:, :, 0] | Temp_{COUT-2} |
| | COUT | X[0: n − 1, 0: n − 1, 0] | w_{COUT-1}[:, :, 0] | Temp_{COUT-1} |
| 2 | 1 | X[0: n − 1, 0: n − 1, 1] | w₀[:, :, 0] | Temp₀ |
| | 2 | X[0: n − 1, 0: n − 1, 1] | w₁[:, :, 0] | Temp₁ |
| | . . . | . . . | . . . | . . . |
| | COUT − 1 | X[0: n − 1, 0: n − 1, 1] | w_{COUT-2}[:, :, 0] | Temp_{COUT-2} |
| | COUT | X[0: n − 1, 0: n − 1, 1] | w_{COUT-1}[:, :, 0] | Temp_{COUT-1} |
| . . . | . . . | . . . | . . . | . . . |
| CIN | 1 | X[0: n − 1, 0: n − 1, CIN − 1] | w₀[:, :, 0] | Temp₀ |
| | 2 | X[0: n − 1, 0: n − 1, CIN − 1] | w₁[:, :, 0] | Temp₁ |
| | . . . | . . . | . . . | . . . |
| | COUT − 1 | X[0: n − 1, 0: n − 1, CIN − 1] | w_{COUT-2}[:, :, 0] | Temp_{COUT-2} |
| | COUT | X[0: n − 1, 0: n − 1, CIN − 1] | w_{COUT-1}[:, :, 0] | Temp_{COUT-1} |

Specifically, the convolution circuit may be configured to perform CIN rounds of convolution operations. Each round of convolution operation may include COUT cycles. Accordingly, a total of CIN×COUT cycles are illustrated in Table 1. In the first round of the CIN rounds of convolution operations, the first data block remains X[0:n−1, 0:n−1, 0], while the second data block traverses the COUT coefficient arrays, w₀, w₁, . . . , and w_{COUT-1}. In the second round, the first data block remains as X[0:n−1, 0:n−1,1], while the second data block traverses the COUT coefficient arrays, and so on, until the CIN^{th} round. In the CIN^{th} round, the first data block remains as X[0:n−1, 0:n−1, CIN-1], while the second data block traverses the COUT coefficient arrays. A coefficient array used in the K^{th} cycle of each round may be determined based on the count K of this cycle (1≤K≤COUT). In the example of Table 1, the coefficient array may be w_{K-1}. In addition, the convolution result obtained in this cycle may be accumulated to a corresponding register of the COUT registers. In the example of Table 1, the corresponding register may be Temp_{K-1}.

Optionally, a corresponding bias value from COUT bias values may be added to a corresponding accumulated value in a corresponding register of the COUT registers, for determining a corresponding result value associated with a corresponding output channel of the COUT output channels. Specifically, a bias value Bias_{K-1} that is associated with the K^{th} output channel may be added to the accumulated value in the register Temp_{K-1}.

A result of calculating a single point on each output channel of the COUT output channel may be obtained through the CIN×COUT cycles illustrated in Table 1. In this process, the number of changes of the first data block is only 1/COUT of that in the method illustrated in the process S100.

It should be understood that the performance sequence illustrated in Table 1 is merely exemplary. In other embodiments, the performance sequence of the CIN rounds may also be changed. In addition, the sequence of the COUT steps within a same round may be changed while the first data block used in the COUT steps keeps unchanged.

In alternative embodiments, instead of keeping the first data block unchanged, the circuitry 3000 may be configured to keep the second data block provided from the coefficient data 1200 to the convolution circuit unchanged across the plurality of consecutive cycles. In these embodiments, the first data block provided from the input data 1100 to the convolution circuit may change in these cycles. For example, for a multi-channel convolution operation with CIN input channels, the circuitry 3000 may be configured to perform CIN rounds of convolution operations. Each round of convolution operations may include consecutive P cycles, where the second data block provided from the coefficient data 1200 to the convolution circuit 3100 keeps unchanged in the consecutive P cycles. P may be an integer not less than two.

In some embodiments, the value of P may be determined based on the size of the input data for each input channel and the predetermined sliding step length. As mentioned above, the input data of each input channel may be represented as a two-dimensional array with a size of L×H, where L represents the width of the two-dimensional array, and H represents the height of the two-dimensional array. If the sliding in each round of convolution operation is performed horizontally on this two-dimensional array (for example, sliding leftwards or rightwards is performed), the maximum value Pₘₐₓ₁ of P may represent an allowed maximum number of horizontal sliding. For example, the value of Pₘₐₓ₁ may be determined based on the size parameter n of the convolution kernel, the width L, and the predetermined horizontal sliding step length D. If the sliding in each round of convolution operations is performed vertically on this two-dimensional array (for example, sliding upwards or downwards is performed), the maximum value Pₘₐₓ₂ of P may represent an allowed maximum number of vertical sliding. For example, the value of Pₘₐₓ₂ may be determined based on the size parameter n of the convolution kernel, the height H, and the predetermined vertical sliding step length D₂. If the sliding in each round of convolution operations is performed horizontally and vertically on this two-dimensional array (for example, a combination of sliding rightwards and downwards is performed), the maximum value Pₘₐₓ₃ of P may represent an allowed maximum number of sliding. For example, the value of Pₘₐₓ₃ may be determined based on the size parameter n of the convolution kernel, the width L, the predetermined horizontal sliding step length D₁, the height H, and the predetermined vertical sliding step length D₂. In some embodiments, the predetermined horizontal sliding step length D may be the same as the predetermined vertical sliding step length D₂. In other embodiments, the predetermined horizontal sliding step length D may be different from the predetermined vertical sliding step length D₂. Any appropriate value P may be selected as needed, as long as the selected value does not exceed the corresponding allowed maximum values (Pₘₐₓ₁, Pₘₐₓ₂, or Pₘₐₓ₃).

For each round of the CIN rounds of convolution operations, in each cycle of the P cycles of this round of convolution operations, the circuitry 3000 may be configured to provide the convolution circuit 3100 with a corresponding portion of input data from a same particular input channel of the plurality of input channels to serve as the first data block, with the provided corresponding portion being determined based at least on the predetermined sliding step length and the cycle. That is, the corresponding portion may change as the cycle changes.

Additionally, in each cycle of the P cycles of the round of convolution operations, the circuitry 3000 may be configured to provide the convolution circuit 3100 with a same coefficient data of a same particular convolution kernel of the plurality of convolution kernels to serve as the second data block. In other words, the same coefficient data keeps unchanged across the P cycles of the round of convolution operations. In the case that the first data block and the second data block used in each cycle are determined in the above manner, the convolution operation may be performed on the determined first data block and second data block by the convolution circuit 3100 to obtain a corresponding convolution result. The corresponding convolution result may be accumulated to a corresponding register of the plurality of registers 3300.

In some embodiments, in one round of convolution operations, a sliding may be performed, based on incrementing of the cycle counts, on the input data of the particular input channel associated with this round, for obtaining a corresponding portion that is to be used as the first data block in each cycle of the P cycles of this round. The predetermined sliding step length may be slid for each cycle. In this way, for two adjacent cycles, the first data block provided to the convolution circuit is two neighboring portions of input data from the particular input channel, of which a second portion is offset by a predetermined sliding step relative to a first portion. The inventors recognized that certain input data has local similarity. Accordingly, the two portions of the input data that are spatially close may have a small difference. As a result, the difference between the first portion and the second portion obtained by the sliding may be very small. Accordingly, the first portion and the second portion provided to the convolution circuit 3100 as the first data blocks of two adjacent cycles may not result in a large number of switches of elements of the convolution circuit 3100. This helps reduce switch power consumption of the convolution circuit. Examples of input data that has significant local similarity include, but are not limited to, image data. For example, there may be large areas of identical or similar patterns in certain image data. In some embodiments where each pixel of the image is represented by eight bits of data, two data values representing two close pixels in the same image generally will not differ in all eight bits. Instead, only a few of the eight bits may be different, while the remaining bits are the same.

In some embodiments, additionally, the second data block provided from the coefficient data of the particular convolution kernel to the convolution circuit is changed across each round of the CIN rounds of convolution operations. In other words, the second data blocks used in different rounds of the CIN rounds of convolution operations may be different portions of the coefficient data of the particular convolution kernel. Specifically, the second data blocks used in each round of convolution operations may come from a portion of the coefficient data of the particular convolution kernel that corresponds to a different input channel. In this way, different portions of the coefficient data of the particular convolution kernel that correspond to the CIN input channels may be traversed in the CIN rounds of convolution operations.

In some embodiments, additionally, in one round of convolution operations, a plurality of result values for a particular output channel of the plurality of output channels that is associated with the particular convolution kernel may be determined based at least on a plurality of accumulated values in the plurality of registers 3300. Optionally, a same bias value may be added to the plurality of accumulated values in the plurality of registers respectively to determine the plurality of result values for the particular output channel. The same bias value may be a bias value in the bias data 1400 that is associated with the particular convolution kernel (that is, associated with the particular output channel). These corresponding result values may represent the plurality of result values associated with the same particular output channel. The plurality of result values may be output as a portion of the multi-channel output data 1300. The use of the bias value is optional and not essential.

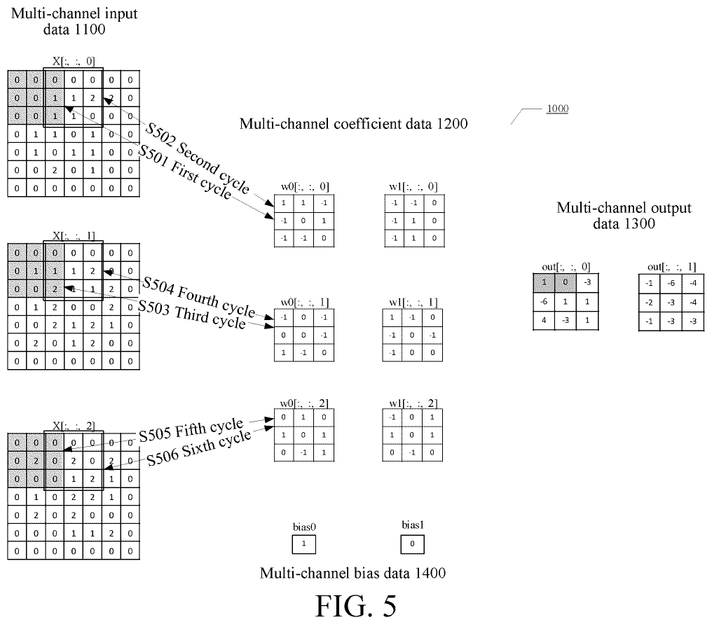

FIG. 5 illustrates a schematic diagram of an exemplary process S500 for performing a multi-channel convolution operation according to an embodiment of the present disclosure. For ease of comparison, the process S500 is performed in the same instance 1000 as the process S100 and the process S400 described above. Therefore, the process S500 is performed with respect to the same multi-channel input data 1100, multi-channel coefficient data 1200, and multi-channel bias data 1400. Accordingly, the process S500 produces the same convolution result as the process S100 and the process S400 (which is the multi-channel output data 1300). However, the process S500 has a different scheduling as compared to the process S100 and the process S400.

As a part of the multi-channel convolution operation, the process S500 may include steps S501 to S506, which are performed in sequence. Steps S501 to S506 may be divided into three rounds (CIN=3), each round including two cycles of convolution operations (P=2). In the exemplary process S500, P is selected as two, to facilitate comparison of the process S500 with the previous process S100 and process S400. It may be understood that P may be selected as another suitable value in alternative embodiments. In the process S500, the first round includes steps S501 and S502, the second round includes steps S503 and S504, and the third round includes steps S505 and S506. For example, the first round, the second round, and the third round may be associated with the coefficient array w₀ of the same convolution kernel (for example, the first convolution kernel). Specifically, the first round, the second round, and the third round may be associated with three different portions of the coefficient array w₀ respectively. For example, the first round may be associated with a portion of the coefficient array w₀ that corresponds to the first input channel (which is w₀[:,:, 0]), the second round may be associated with a portion of the coefficient array w₀ that corresponds to the second input channel (which is w₀[:,:, 1]), and the third round may be associated with a portion of the coefficient array w₀ that corresponds to the third input channel (which is w₀[:,:, 2]).

Step S501 in the first round may be performed in the first cycle. In this step, a portion of input data X0 from the first input channel of the multi-channel input data 1100, which is X[0:2, 0:2, 0], is provided to the convolution circuit to serve as a first data block. X[0:2, 0:2, 0] is illustrated in shade. The portion of the coefficient array w₀ corresponding to the first input channel, which is w₀[:,:, 0], is provided to the convolution circuit as the second data block. Accordingly, the convolution operation may be calculated as: R=X[0:2, 0:2, 0]* w₀[:,:, 0]=1. The result R of the current convolution operation may be stored in a register Temp₀.

The process S500 may then proceed to step S502 in the first round. Step S502 may occur in the second cycle subsequent to the first cycle. In step S502, the second data block provided to the convolution circuit keeps unchanged, that is, remains as w₀[:,:, 0]. The first data block is changed to another portion of the input data X0 of the first input channel. The other portion may be obtained by sliding the previous first data block (which is X[0:2, 0:2, 0]) in the input data X0 by the predetermined sliding step length. In the example of FIG. 5, the predetermined sliding step length is two (that is, two data points), and the sliding direction is rightwards. Therefore, the obtained other portion may be represented as X[0:2, 2:4, 0], which is used as the first data block in step S502, as illustrated by the bold box in FIG. 5. Accordingly, the convolution operation may be calculated as: R=X[0:2, 2:4, 0]* w₀[:,:, 0]=−1. The result R of the current convolution operation may be stored in a register Temp₁.

The process S500 may then proceed to the second round. The second round may start from step S503. Step S503 may occur in the third cycle subsequent to the second cycle. In step S503, the first data block is changed to a portion of input data X1 from the second input channel of the multi-channel input data 1100, which is X[0:2, 0:2, 1]. The second data block is changed to a portion of the coefficient array w₀ of the multi-channel coefficient data 1200 corresponding to the second input channel, which is w₀[:,:, 1]. In this case, the result R of the convolution operation of the convolution circuit may be calculated as: R=X[0:2, 0:2, 1]* w₀[:,:, 1]=−1. The result R of the current convolution operation may be accumulated to the previous value (which is 1) in the register Temp₀. In this case, the accumulated value in the register Temp₀ becomes 1+(−1)=0.

The process S500 may then proceed to step S504 in the second round. Step S504 may occur in the fourth cycle subsequent to the third cycle. In step S504, the second data block provided to the convolution circuit keeps unchanged, that is, remains as w₀[:,:, 1]. The first data block is changed to another portion of the input data X1 of the second input channel. The other portion may be obtained by sliding the previous first data block (which is X[0:2, 0:2, 1]) in the input data X1 by the predetermined sliding step length. In the example of FIG. 5, the obtained other portion may be represented as X[0:2, 2:4, 1], which is used as the first data block in step S504, as illustrated by the bold box in FIG. 5. Accordingly, the convolution operation may be calculated as: R=X[0:2, 2:4, 1]* w₀[:,:, 1]=−1. The result R of the current convolution operation may be accumulated to the previous value (which is, −1) stored in the register Temp₁. In this case, the accumulated value in the register Temp₁ becomes (−1)+(−1)=−2.

The process S500 may then proceed to the third round. The third round may start from step S505. Step S505 may occur in the fifth cycle subsequent to the fourth cycle. In step S505, the first data block may be changed to a portion of input data X2 from the third input channel, which is, X[0:2, 0:2, 2]. The second data block may be changed to a portion of the coefficient array w₀ corresponding to the third input channel, which is, w₀[:,:, 2]. In this case, the result R of the convolution operation of the convolution circuit may be calculated as: R=X[0:2, 0:2, 2]* w₀[:,:, 2]=0. The result R of the current convolution operation may be accumulated to the previous value (which is, 0) stored in the register Temp₀. In this case, the accumulated value in the register Temp₀ becomes 1+(−1)+0=0.

The process S500 may then proceed to step S506 in the third round. Step S506 may occur in the sixth cycle subsequent to the fifth cycle. In step S506, the second data block provided to the convolution circuit keeps unchanged, that is, remains as w₀[:,:, 2]. The first data block is changed to another portion of the input data X2 of the third input channel. The other portion may be obtained by sliding the previous first data block (which is, X[0:2, 0:2, 2]) in the input data X2 by the predetermined sliding step length. In the example of FIG. 5, the obtained other portion may be represented as X[0:2, 2:4, 2], which is used as the first data block in step S506, as illustrated by the bold box in FIG. 5. Accordingly, the convolution operation may be calculated as: R=X[0:2, 2:4, 2]* w₀[:,:, 2]=1. The result R of the current convolution operation may be accumulated to the previous value (which is, −2) stored in the register Temp₁. In this case, the accumulated value in the register Temp₁ becomes 1+(−2)=−1.

Additionally, the bias value (which is, bias₀) associated with the first convolution kernel may be added to the current accumulated value in the registers Temp₀ and Temp₁. Accordingly, corresponding data points of the first output array in the multi-channel output data 1300 may be obtained, that is, out[0,0,0]=0+1=1 and out[0,1,0]=(−1)+1=0, as illustrated in shade. Each accumulated value in the registers Temp₀ and Temp₁ may be cleared to zero.

In the process S500, the second data block from the multi-channel coefficient data 1200 may change across different rounds. For the two calculation cycles in a same round, the second data block keeps unchanged. Therefore, as compared with the process S100, the process S500 may reduce the overall change frequency of the first data block and the second data block of the convolution circuit. For example, the first data block changes six times and the second data block changes six times in the above described six cycles of the process S100, and a sum of the two numbers of changes is twelve. In comparison, the first data block changes six times and the second data block changes three times in the above described six cycles of the process S500, and the sum of the two numbers of changes is nine. By reducing the overall change frequency of the first data block and the second data block, the switch frequencies of logic gate circuits forming the convolution circuit may be advantageously reduced, thereby reducing the switch power consumption of these logic gate circuits.

It should be understood that the value of P (that is, P=2) selected in the process S500 is exemplary. In other embodiments, P may be a different value so that each round of convolution operations spans more cycles. For example, P may be selected as three in another embodiment for instance 1000. In this case, each round of the three rounds of convolution operations of the process S500 may span three cycles. Accordingly, the first round of convolution operations may further include additional steps after steps S501 and S502. In this additional step, the second data block provided to the convolution circuit keeps unchanged, that is, remains as w₀[:,:, 0]. The first data block is changed to another portion of the input data X0 of the first input channel. The other portion may be obtained by sliding the previous first data block (which is X[0:2, 2:4, 0]) in the input data X0 rightwards by the predetermined sliding step of two. The obtained other portion may be represented as X[0:2, 4:6, 0], which is used as the first data block in this additional step. The convolution operation may be calculated as: R=X[0:2, 4:6, 0]* w₀[:,:, 0]. The result R of the current convolution operation may be stored in a register Temp₂.

It may be understood that the second round and the third round of convolution operations of the process S500 may each have a similar additional step. It should be understood that the start point (which is X[0:2, 0:2, 0]) and the direction (which is, rightwards) of the sliding illustrated in the process S500 are exemplary. In other embodiments, the sliding may have a different start point and/or a different direction. In some embodiments, the first data block may slide leftwards starting from X[0:2, 4:6, 0]. In some embodiments, the first data block may slide downwards starting from X[0:2, 0:2, 0]. In some embodiments in which P is greater than three, the first data block may slide rightwards starting from X[0:2, 0:2, 0] and, after reaching X[0:2, 4:6, 0], continue to slide downwards. There may be various manners of sliding on the input data, depending on the value of P, the sliding direction, and the sliding step length.

Additionally, the first data blocks that are used in two adjacent cycles in a same round are two portions of input data of a same input channel that are close to each other. For input data having local similarity, the difference between the two portions is very likely to be small. Therefore, although the first data block changes in the two consecutive cycles, this change may be sufficiently small. The sufficiently small change may not result in a large number of switches of elements of the convolution circuit 3100. This may advantageously further reduce the switch power consumption of the convolution circuit.

It should be understood that the process S500 may include additional rounds. For example, some additional rounds may be performed on the first data block that is obtained by further sliding, as previously described. For another example, some additional rounds may be performed on the coefficient array w₁ of the second convolution kernel. Additional rounds may be performed until the multi-channel input data 1100 has been traversed, thereby obtaining the remaining data points in the first output array and the second output array of the multi-channel output data 1300.

Description is made in the following for the multi-channel input data 1100 and the multi-channel coefficient data 1200, which are more general. As mentioned above, the multi-channel input data 1100 may be represented as a multi-dimensional array with the size of L×H×CIN, where CIN represents the number of the input channels, L represents the width of the two-dimensional array corresponding to the input data of each input channel, and H represents the height of the two-dimensional array corresponding to the input data of each input channel. The multi-channel coefficient data 1200 may be represented as COUT coefficient arrays, w₀, w₁, . . . , and w_{COUT-1}. Each of the coefficient array may be represented as a multi-dimensional array with a size of n×n×CIN. In this case, the first data block and the second data block provided to the convolution circuit every cycle may be selected as illustrated in Table 2, where D may be a positive integer representing a predetermined sliding step length.

TABLE 2

| | Cycle# in the | | | |
|---|---|---|---|---|
| Round# | current round | First data block | Second data block | Register |
| 1 | 1 | X[0: n − 1, 0: n − 1, 0] | w₀[:, :, 0] | Temp₀ |
| | 2 | X[0: n − 1, D: D + n − 1, 0] | w₀[:, :, 0] | Temp₁ |
| | . . . | . . . | . . . | . . . |
| | P | X[0: n − 1, (P − 1) × D: (P − | w₀[:, :, 0] | Temp_{P-1} |
| | | 1) × D + n − 1, 0] | | |
| 2 | 1 | X[0: n − 1, 0: n − 1, 1] | w₀[:, :, 1] | Temp₀ |
| | 2 | X[0: n − 1, D: D + n − 1, 1] | w₀[:, :, 1] | Temp₁ |
| | . . . | . . . | . . . | . . . |
| | P | X[0: n − 1, (P − 1) × D: (P − | w₀[:, :, 1] | Temp_{P-1} |
| | | 1) × D + n − 1, 1] | | |
| . . . | . . . | . . . | . . . | . . . |
| CIN | 1 | X[0: n − 1, 0: n − 1, CIN − 1] | w₀[:, :, CIN − 1] | Temp₀ |
| | 2 | X[0: n − 1, D: D + n − 1, | w₀[:, :, CIN − 1] | Temp₁ |
| | | CIN − 1] | | |
| | . . . | . . . | . . . | . . . |
| | P | X[0: n − 1, (P − 1) × D: (P − | w₀[:, :, CIN − 1] | Temp_{P-1} |
| | | 1) × D + n − 1, CIN − 1] | | |

Specifically, the convolution circuit may be configured to perform CIN rounds of convolution operations. Each round of convolution operations may include P cycles. Accordingly, a total of CIN×P cycles are illustrated in Table 2. In the first round, the second data block remains as w₀[:,:, 0], while the first data block traverses P portions of the first input data in a sliding manner. In the second round, the second data block remains as w₀[:,:, 1], while the first data block traverses P portions of the second input data in a sliding manner, and so on, until the CIN^{th} round. In the CIN^{th} round, the second data block remains as w₀[:,:, CIN-1], while the first data block traverses P portions of the CIN^{th} input data in a sliding manner. The corresponding portion of the input data used in the K^{t} cycle of each round may be determined based on the count K of this cycle (1≤K≤P). In addition, the convolution result obtained in this cycle may be accumulated to a corresponding register of the P registers. In the example of Table 2, the corresponding register may be Temp_{K-1}.

Optionally, a same bias value from COUT bias values that are associated with the COUT output channels may be added to a corresponding accumulated value in a corresponding register of the P registers, for determining P result values associated with a same output channel of the COUT output channels. P points of results on a single output channel may be obtained through the CIN×P cycles illustrated in Table 2. In this process, the change rate of the second data block is only 1/P of that in the method illustrated in the process S100. Moreover, due to the local similarity of the input data, the switch of logic gate elements caused by changes of the first data block may also be reduced, which further reduces the switch power consumption of the convolution circuit.

It should be understood that the performance sequence illustrated in Table 2 is merely exemplary. In other embodiments, the performance sequence of the CIN rounds may also be changed. In addition, the sequence of the P steps in a same round may be changed, while the second data block used by the P steps keeps unchanged. Furthermore, the sliding illustrated in Table 2 is rightward sliding. As mentioned above, different sliding directions may be used in other embodiments.

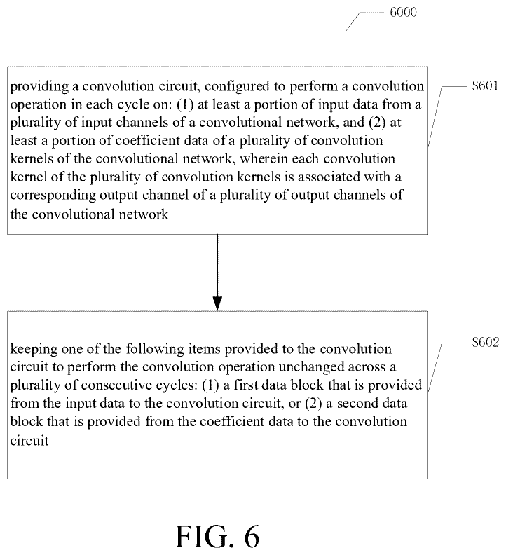

FIG. 6 illustrates a flowchart of an exemplary method 6000 for convolution operations according to an embodiment of the present disclosure. The method 6000 may include steps S601 and S602. Step S601 may include providing a convolution circuit. The convolution circuit may be configured to perform a convolution operation in each cycle on: (1) at least a portion of input data from a plurality of input channels of a convolutional network, and (2) at least a portion of coefficient data of a plurality of convolution kernels of the convolutional network. Each of the plurality of convolution kernels of the convolutional network may be associated with a corresponding output channel of a plurality of output channels of the convolutional network. Examples of the convolution circuit may include the convolution circuit 3100 previously described. Step S602 may include keeping one of the following items provided to the convolution circuit to perform the convolution operation unchanged across a plurality of consecutive cycles: (1) a first data block that is provided from the input data to the convolution circuit, or (2) a second data block that is provided from the coefficient data to the convolution circuit. In some embodiments, step S602 may be performed, for example, by the control circuit 3200 described above.

In optional embodiments, the method 6000 may include one or more additional steps. In some embodiments, the number of the plurality of input channels is CIN, and the number of the plurality of output channels is COUT. The method 6000 may include configuring the convolution circuit to perform CIN rounds of convolution operations, each round of convolution operations including a plurality of consecutive cycles, where: the first data block provided from the input data to the convolution circuit keeps unchanged during the plurality of consecutive cycles; or the second data block provided from the coefficient data to the convolution circuit keeps unchanged during the plurality of consecutive cycles.

In some embodiments, the plurality of consecutive cycles are COUT cycles. The method 6000 may include: in each cycle of the consecutive COUT cycles, providing the convolution circuit with same input data from a same particular input channel to serve as the first data block; providing the convolution circuit with corresponding coefficient data of a corresponding convolution kernel of the plurality of convolution kernels to serve as the second data block, where the corresponding convolution kernel is determined based at least on the cycle; performing a convolution operation on the first data block and the second data block through the convolution circuit to obtain a corresponding convolution result; and accumulating the corresponding convolution result to a corresponding register of a plurality of registers.

In some of the above embodiments, the method 6000 may further include changing, across each round of the CIN rounds of convolution operations, the particular input channel from which the first data block is obtained.

In some of the above embodiments, the method 6000 may further include determining, based at least on a plurality of accumulated values in the plurality of registers, a plurality of result values associated with the plurality of output channels. Specifically, the method may include adding a corresponding bias value of a plurality of bias values to a corresponding accumulated value in a corresponding register of the plurality of registers, to determine a corresponding result value associated with a corresponding output channel of the plurality of output channels.

In some other embodiments, the plurality of consecutive cycles are P cycles. The method 6000 may include in each cycle of the consecutive P cycles: providing the convolution circuit with a corresponding portion of input data from a same particular input channel of the plurality of input channels to serve as the first data block, where the corresponding portion is determined based at least on a predetermined sliding step length and the cycle; providing the convolution circuit with same coefficient data of a same particular convolution kernel of the plurality of convolution kernels to serve as the second data block; performing a convolution operation on the first data block and the second data block through the convolution circuit to obtain a corresponding convolution result; and accumulating the corresponding convolution result to a corresponding register of a plurality of registers.

In some of the above embodiments, the method 6000 may further include providing, in two adjacent cycles of the consecutive P cycles, the convolution circuit with a first portion and a second portion of the input data from the particular input channel respectively, where the second portion is offset by the predetermined sliding step length relative to the first portion.

In a preferred embodiment, the input data used by the method 6000 may be image data.

In some of the above embodiments, the method 6000 may further include changing, across each round of the CIN rounds of convolution operations, the second data block provided from the coefficient data of the particular convolution kernel to the convolution circuit.

In some of the above embodiments, the method 6000 may further include determining, based at least on a plurality of accumulated values in the plurality of registers, a plurality of result values for a particular output channel of the plurality of output channels that is associated with the particular convolution kernel. For example, a same bias value may be added to the plurality of accumulated values in the plurality of registers respectively to determine the plurality of result values for the particular output channel.

In some embodiments, the input data used by the method 6000 is associated with at least one of. original input data of the convolutional network; feature data that is generated by one or more layers of the convolutional network based on the original input data; or a combination of both.

In some embodiments, the coefficient data used by the method 6000 is associated with one or more weight coefficients of the convolutional network.

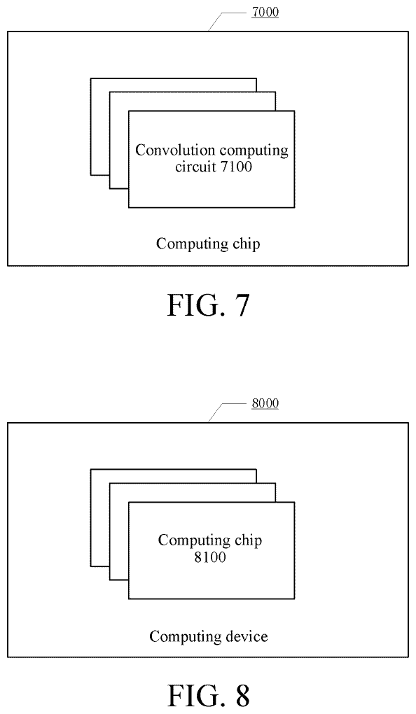

FIG. 7 illustrates a schematic diagram of a computing chip 7000 according to an embodiment of the present disclosure. The computing chip 7000 may include one or more convolution computing circuits 7100. Examples of the convolution computing circuit 7100 may include the circuitry 3000 described previously in related to FIG. 3. The computing chip 7000 may be configured to perform one or more functions associated with convolution operations. In some embodiments, the computing chip 7000 may be implemented as a dedicated CNN chip. Those skilled in the art may understand that the computing chip 7000 may include other components, which are not illustrated.

FIG. 8 illustrates a schematic diagram of a computing device 8000 according to an embodiment of the present disclosure. The computing device 8000 may include a computing chip 8100. Examples of the computing chip 8100 may include the computing chip 7000 described above in related to FIG. 7. The computing device 8000 may be configured to perform one or more functions associated with convolution operations. In some embodiments, the computing device 8000 may be implemented as a dedicated CNN server. In some embodiments, the computing device 8000 may be a general-purpose computing device installed with the computing chip 8100. Those skilled in the art may understand that the computing device 8000 may include other components, which are not illustrated.

The present disclosure may also provide a computing device, which may include one or more processors and a memory storing computer-executable instructions that, when executed by the one or more processors, cause the one or more processors to perform the method according to any of the preceding embodiments of the present disclosure. A computing device may include a processor (s) and a memory storing computer-executable instructions that, when executed by the processor (s), cause the processor (s) to perform a method according to any of the preceding embodiments of the present disclosure. For example, the processor may control the operation of the circuit 3000. The processor (s) may be, for example, a central processing unit (CPU) of a computing device. The processor (s) may be any type of general-purpose processor, or may be a processor specially designed for data transmission type conversion of SOC chips, such as an application specific integrated circuit (“ASIC”). The memory may include various computer-readable media accessible by the processor (s). In various embodiments, the memory described herein may include volatile and nonvolatile media, removable and non-removable media. For example, the memory may include any combination of random access memory (“RAM”), dynamic RAM (“DRAM”), static RAM (“SRAM”), read-only memory (“ROM”), flash memory, cache memory and/or any other type of non-transitory computer-readable medium. The memory may store instructions that, when executed by the processor, cause the processor to perform the data transmission type conversion method according to any of the foregoing embodiments of the present disclosure.

In addition, the present disclosure may also provide a non-transitory storage medium having stored thereon computer-executable instructions that, when executed by one or more processors, cause the one or more processors to perform the method according to any of the foregoing embodiments of the present disclosure.

The terms “left”, “right”, “front”, “rear”, “top”, “bottom”, “above”, “under”, “upper”, “lower”, and the like in the specification and the claims, if present, are used for a descriptive purpose and are not necessarily used for describing an unchanged relative position. It is to be understood that the words used in such a way are interchangeable in proper circumstances so that the embodiments of the present disclosure described herein, for example, can be operated in other orientations that are different from those shown herein or those described otherwise.

For example, when the device in the accompanying drawings is turned upside down, a feature originally described as being “above” another feature may be described as being “under” another feature in this case. The device may alternatively be oriented in other manners (rotated 90 degrees or in other orientations). In this case, a relative spatial relationship will be interpreted correspondingly.

In the specification and the claims, when an element is referred to as being “above” another element, “attached” to another element, “connected” to another element, “coupled” to another element, “in contact” with another element, or the like, the element may be directly above the another element, directly attached to the another element, directly connected to the another element, directly coupled to the another element, or directly in contact with the another element; or one or more intermediate elements may exist. In contrast, when an element is referred to as being “directly above” another element, “directly attached” to another element, “directly connected” to another element, “directly coupled” to another element, or “in direct contact” with another element, no intermediate element exists. In the specification and the claims, a feature being arranged as being “adjacent” to another feature may mean that the feature has a part that overlaps with the adjacent feature or that is located above or under the adjacent feature.

As used herein, the term “exemplary” means “used as an example, instance, or illustration”, and not as a “model” to be accurately copied. Any implementation exemplarily described herein is not necessarily to be construed as preferred or advantageous over other implementations. In addition, the present disclosure is not limited by any stated or implied theory provided in the technical field, background, summary, or detailed description.

As used herein, the term “substantially” means that any minor variation caused by a defect of a design or manufacturing, a tolerance of a device or an element, environmental impact, and/or other factors is included. The term “substantially” also allows for a difference from a perfect or ideal situation caused by parasitic effect, noise, and other practical consideration factors that may exist in practical implementation.

In addition, terms like “first” and “second” may also be used herein for a reference purpose only, and therefore are not intended for a limitation. For example, the terms “first”, “second” and other such numerical terms relating to a structure or an element do not imply a sequence or an order unless the context clearly indicates otherwise.

It is to be further understood that the term “comprise/include”, when used herein, specifies the presence of stated features, integers, steps, operations, units, and/or components, but do not preclude the presence or addition of one or more other features, integers, steps, operations, units, and/or components, and/or combinations thereof.

In the present disclosure, the term “provide” is used broadly for covering all manners of obtaining an object. Therefore, “providing an object” includes but is not limited to “purchasing”, “preparing/manufacturing”, “arranging/setting”, “installing/assembling”, and/or “ordering” the object, etc.

As used herein, the term “and/or” includes any and all combinations of one or more of associated listed items. The terms used herein are merely for the purpose of describing specific embodiments but not intended to limit the present disclosure. The singular forms “a”, “an”, and “the” as used herein are intended to include plural forms as well, unless otherwise clearly stated in the context.

A person skilled in the art should appreciate that the boundaries between the operations as described above are merely illustrative. A plurality of operations may be combined into a single operation, a single operation may be distributed in an additional operation, and operations may be performed at least partially overlapping in time. In addition, alternative embodiments may include a plurality of instances of a specific operation, and an operation order may be changed in various other embodiments. Other modifications, changes, and replacements, however, are also possible. Aspects and elements of all embodiments disclosed above may be combined in any manner and/or combined with aspects or elements of other embodiments to provide a plurality of additional embodiments. Therefore, the specification and the accompanying drawings are to be regarded as illustrative rather than restrictive.

Although some specific embodiments of the present disclosure are described in detail by examples, a person skilled in the art is to understand that the foregoing examples are merely used for description, but not for limiting the scope of the present disclosure. Each embodiment disclosed herein may be combined in any combination without departing from the spirit and scope of the present disclosure. A person skilled in the art is to further understand that various modifications may be made to the embodiments without departing from the scope and spirit of the present disclosure. The scope of the present disclosure is defined by the appended claims.

1. A circuitry for a convolution operation, comprising:
a convolution circuit, configured to perform a convolution operation in each cycle on: (1) at least a portion of input data from a plurality of input channels of a convolutional network, and (2) at least a portion of coefficient data of a plurality of convolution kernels of the convolutional network, wherein each convolution kernel of the plurality of convolution kernels is associated with a corresponding output channel of a plurality of output channels of the convolutional network;
wherein the circuitry is configured to keep one of the following items provided to the convolution circuit to perform the convolution operation unchanged across a plurality of consecutive cycles: (1) a first data block that is provided from the input data to the convolution circuit, or (2) a second data block that is provided from the coefficient data to the convolution circuit.

2. The circuitry of claim 1, wherein a number of the plurality of input channels is CIN, a number of the plurality of output channels is COUT, and the circuitry is configured to:
perform CIN rounds of convolution operations, each round of convolution operations comprising consecutive COUT cycles, wherein the first data block provided from the input data to the convolution circuit keeps unchanged during the consecutive COUT cycles.

3. The circuitry of claim 2, wherein the circuitry is configured to:
in each cycle of the consecutive COUT cycles,
provide the convolution circuit with same input data from a same particular input channel to serve as the first data block;
provide the convolution circuit with corresponding coefficient data of a corresponding convolution kernel of the plurality of convolution kernels to serve as the second data block, wherein the corresponding convolution kernel is determined based at least on the cycle;
perform the convolution operation on the first data block and the second data block through the convolution circuit to obtain a corresponding convolution result; and
accumulate the corresponding convolution result to a corresponding register of a plurality of registers.

4. The circuitry of claim 3, wherein the circuitry is configured to:
change, across each round of the CIN rounds of convolution operations, the particular input channel from which the first data block is obtained.

5. The circuitry of claim 4, wherein the circuitry is further configured to:
determine, based on at least a plurality of accumulated values in the plurality of registers, a plurality of result values associated with the plurality of output channels.

6. The circuitry of claim 5, wherein the circuitry is further configured to:
add a corresponding bias value of a plurality of bias values to a corresponding accumulated value in a corresponding register of the plurality of registers, to determine a corresponding result value associated with a corresponding output channel of the plurality of output channels.

7. The circuitry of claim 1, wherein a number of the plurality of input channels is CIN, and the circuitry is configured to:
perform CIN rounds of convolution operations, each round of convolution operations comprising consecutive P cycles, wherein the second data block provided from the coefficient data to the convolution circuit keeps unchanged during the consecutive P cycles, wherein P is an integer not less than two.

8. The circuitry of claim 7, wherein the circuitry is configured to:
in each cycle of the consecutive P cycles,
provide the convolution circuit with a corresponding portion of input data from a same particular input channel of the plurality of input channels to serve as the first data block, wherein the corresponding portion is determined based at least on a predetermined sliding step length and the cycle;
provide the convolution circuit with same coefficient data of a same particular convolution kernel of the plurality of convolution kernels to serve as the second data block;
perform the convolution operation on the first data block and the second data block through the convolution circuit to obtain a corresponding convolution result; and
accumulate the corresponding convolution result to a corresponding register of a plurality of registers.

9. The circuitry of claim 8, wherein the circuitry is configured to:
provide, in two adjacent cycles of the consecutive P cycles, the convolution circuit with a first portion and a second portion of the input data from the particular input channel respectively, wherein the second portion is offset by the predetermined sliding step length relative to the first portion.

10. The circuitry of claim 9, wherein the input data is image data.

11. The circuitry of claim 8, wherein the circuitry is further configured to:
change, across each round of the CIN rounds of convolution operations, the second data block that is provided from the coefficient data of the particular convolution kernel to the convolution circuit.

12. The circuitry of claim 8, wherein the circuitry is configured to:
determine, based at least on a plurality of accumulated values in the plurality of registers, a plurality of result values for a particular output channel of the plurality of output channels that is associated with the particular convolution kernel.

13. The circuitry of claim 12, wherein the circuitry is configured to:
add a same bias value to the plurality of accumulated values in the plurality of registers respectively to determine the plurality of result values for the particular output channel.

14. The circuitry of claim 1, wherein the convolution circuit comprises a multiplier and an adder comprising logic gate elements configured to perform the convolution operation through a multiplication-accumulation operation.

15. The circuitry of claim 1, wherein the input data is associated with at least one of:
original input data of the convolutional network; or
feature data that is generated by one or more layers of the convolutional network based on the original input data.

16. The circuitry of claim 1, wherein the coefficient data is associated with one or more weight coefficients of the convolutional network.

17. A computing chip, comprising the circuitry for the convolution operation of claim 1.

18. A computing device, comprising the computing chip of claim 17.

19. A method for a convolution operation, comprising:
providing a convolution circuit, configured to perform a convolution operation in each cycle on: (1) at least a portion of input data from a plurality of input channels of a convolutional network, and (2) at least a portion of coefficient data of a plurality of convolution kernels of the convolutional network, wherein each convolution kernel of the plurality of convolution kernels is associated with a corresponding output channel of a plurality of output channels of the convolutional network;
keeping one of the following items provided to the convolution circuit to perform the convolution operation unchanged across a plurality of consecutive cycles: (1) a first data block that is provided from the input data to the convolution circuit, or (2) a second data block that is provided from the coefficient data to the convolution circuit.

20. The method of claim 19, wherein a number of the plurality of input channels is CIN, and the method comprises:
configuring the convolution circuit to perform CIN rounds of convolution operations, each round of convolution operations comprising a plurality of consecutive cycles, wherein:
the first data block provided from the input data to the convolution circuit keeps unchanged during the plurality of consecutive cycles; or
the second data block provided from the coefficient data to the convolution circuit keeps unchanged during the plurality of consecutive cycles.
